(19) United States
(12) Patent Application Publication
(10) Pub. No.: US 2004/0216158 A1
(43) Pub. Date: Oct. 28, 2004

(54) Preferred entertainment guide

(75) Inventor: Carlos J. Blas, Pflugerville, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY (US)

(21) Appl. No.: 10/422,023

(22) Filed: Apr. 23, 2003

(51) Int. Cl. G06F 3/00; H04N 5/445; G06F 13/00

(52) U.S. Cl. 725/46; 725/47

(57) ABSTRACT

A preferred entertainment guide with a prioritized list of programs is provided. The preferred entertainment guide receives a program listing and a priority listing of programs that are preferred by the viewer or listener. The preferred entertainment guide searches the program listing for programs that match the priority listing. Matching programs are placed in a results list in priority order. If a program exists in the results list that has a higher priority than the program currently being viewed, then the preferred entertainment may alert the viewer. The viewer may then select a program from the results list.

### BACKGROUND OF THE INVENTION

1. Technical Field

The present invention relates to entertainment channel selection and, in particular, to selection of a channel or program from a program guide. Still more particularly, the present invention provides a method, apparatus, and program for providing a preferred entertainment guide with a prioritized list of programs.

2. Description of Related Art

Entertainment available on television and radio is a popular form of stress relief. Many people turn on a television or radio in search of a diversion that is needed in everyday life. For this reason, the search for preferred entertainment should be simple.

However, with the popularity of digital cable television, satellite television, and satellite radio, the amount of available entertainment is increasing at a staggering rate. Some digital cable systems or satellite television systems provide in excess of eight hundred channels and this number is expected to grow. These systems typically provide a navigable program guide, which allows a viewer to page through the program and channel listings. However, the time needed to digest such an excessive number of channels and programs is prohibitive.

For example, it may take ten minutes to locate a program of interest. This program may be thirty minutes long. When the user switches to the program of interest, the program may be in a commercial break. Thus, the user may miss half of the program, because the viewer is burdened with a generous amount of available content, which is otherwise considered a luxury.

Personal video recorders allow a viewer to search program listings for a particular theme or themes and to record various channels at once. The programs may then be viewed at a later time at the leisure of the viewer. However, this does not solve the problem of locating programs of interest that are currently starting or in progress. For example, a viewer may watch a previously recorded program without knowing that a better program is currently being broadcast.

Therefore, it would be advantageous to provide a preferred entertainment guide to allow a viewer to quickly identify programs of interest.

### SUMMARY OF THE INVENTION

The present invention provides a preferred entertainment guide with a prioritized list of programs. The preferred entertainment guide may be a separate device that works in combination with a media receiver. The preferred entertainment guide may also be integrated within a media receiver unit, such as a digital cable or satellite receiver. The preferred entertainment may also be integrated within a television or radio itself. The preferred entertainment guide receives a program listing and a priority listing of programs that are preferred by the viewer or listener.

The preferred entertainment guide searches the program listing for programs that match the priority listing. Matching programs are placed in a results list in priority order. If a program exists in the results list that has a higher priority than the program currently being viewed, then the preferred entertainment may alert the viewer. At predetermined periods, such as every half hour, the preferred entertainment guide will generate a new results list. At this time, the viewer may select a program from the results list.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A and 1B depict pictorial representations of television viewing systems in accordance with a preferred embodiment of the present invention;

FIGS. 2A and 2B are pictorial representations of radio systems in accordance with a preferred embodiment of the present invention

FIG. 3 depicts a pictorial representation of a network of data processing systems in which the present invention may be implemented;

FIG. 4 is an exemplary block diagram of a preferred entertainment guide device in accordance with a preferred embodiment of the present invention;

FIGS. 5A-5E illustrate example television screens of display with preferred entertainment guide interfaces in accordance with a preferred embodiment of the present invention

FIG. 6 is a screen of display for a remote preferred entertainment guide interface in accordance with a preferred embodiment of the present invention;

FIG. 7 illustrates a remote control device for use with a preferred entertainment guide device in accordance with a preferred embodiment of the present invention; and

FIG. 8 is a flowchart illustrating the operation of a preferred entertainment guide in accordance with a preferred embodiment of the present invention.

### DETAILED DESCRIPTION OF THE PREFERRED EMBODIMENT

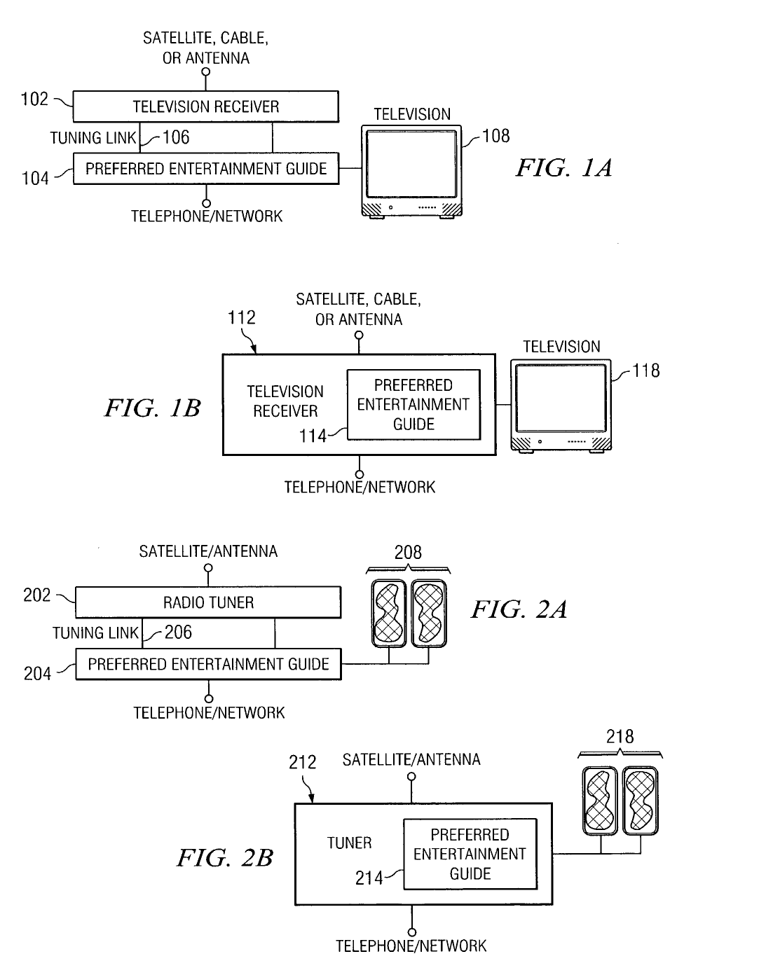

With reference now to the figures, FIGS. 1A and 1B depict pictorial representations of television viewing systems in accordance with a preferred embodiment of the present invention. More particularly, with reference to FIG. 1A, the television viewing system includes television receiver 102, preferred entertainment guide 104, and television 108. Television receiver 102 receives a signal from a satellite dish, cable connection, or antenna.

Preferred entertainment guide 104 is connected between television receiver 102 and television 108. The preferred entertainment guide may receive a program guide from a telephone connection or network. Alternatively, the program guide may be received by other media, such as removable media, radio frequency communication, infrared communication, etc. For example, the program guide may be received or updated using a compact disk.

To communicate with the telephone connection or network, the preferred entertainment guide may include a modem or network adapter. The network may be a local area network (LAN), such as a home network. A network adapter may be connected to a broadband modem, Internet connection sharing computer, a hub, or a router. In accordance with a preferred embodiment of the present invention, preferred entertainment guide is connected to the Internet via a dial-up connection or a broadband modem.

Preferred entertainment guide 104 receives video from television receiver 102 and presents the video on television 108. The preferred entertainment guide may also present a program guide on the television. The program guide may be presented on a portion of the screen or superimposed over the video from television receiver 102. The viewer may select preferred programs from the program guide. These preferred programs may be placed in a priority order.

While the viewer is viewing television programs, the preferred entertainment guide searches the program listing for programs that match the priority listing. Matching programs are placed in a results list in priority order. If a program exists in the results list that has a higher priority than the program currently being viewed, then the preferred entertainment may alert the viewer. At predetermined periods, such as every half hour or five minutes before each half hour, the preferred entertainment guide may generate a new results list. At this time, the viewer may select a program from the results list.

The preferred entertainment guide may use tuning link 106 to change channels in the television receiver. The tuning link may be, for example, an infrared communications link or a serial cable. When the viewer selects a program from the results list, the preferred entertainment guide uses the tuning link to change channels.

The preferred entertainment guide may be a separate device that works in combination with the television receiver. The preferred entertainment guide and television receiver may also be integrated within the television itself.

Turning now to FIG. 1B, the television viewing system includes television receiver 112 and television 118. In the example shown in FIG. 1B, preferred entertainment guide 114 is integrated within television receiver 112. The television receiver may receive a program guide from a telephone connection or network. Alternatively, the program guide may be received by other media, such as removable media, radio frequency communication, infrared communication, etc. For example, the program guide may be received or updated using a compact disk.

Preferred entertainment guide 114 may present a program guide on the television. The program guide may be presented on a portion of the screen or superimposed over the video from television receiver 112. The viewer may select preferred programs from the program guide. These preferred programs may be placed in a priority order.

While the viewer is viewing television programs, the preferred entertainment guide searches the program listing for programs that match the priority listing. Matching programs are placed in a results list in priority order. If a program exists in the results list that has a higher priority than the program currently being viewed, then the preferred entertainment may alert the viewer. At predetermined periods, such as every half hour or five minutes before each half hour, the preferred entertainment guide may generate a new results list. At this time, the viewer may select a program from the results list.

With reference now to FIGS. 2A and 2B, pictorial representations of radio systems are shown in accordance with a preferred embodiment of the present invention. More particularly, with reference to FIG. 2A, the radio system includes radio tuner 202, preferred entertainment guide 204, and speakers 208. Radio tuner 202 receives a signal from a satellite receiver or antenna.

Preferred entertainment guide 204 is connected between radio tuner 202 and speakers 208. The preferred entertainment guide may receive a program guide from a telephone connection or network. Alternatively, the program guide may be received by other media, such as removable media, radio frequency communication, infrared communication, etc. For example, the program guide may be received or updated using a compact disk.

To communicate with the telephone connection or network, the preferred entertainment guide may include a modem or network adapter. The network may be a local area network (LAN), such as a home network. A network adapter may be connected to a cellular telephone connection, radio transceiver, broadband modem, Internet connection sharing computer, hub, or router. In accordance with a preferred embodiment of the present invention, preferred entertainment guide is connected to the Internet via a dial-up connection or a broadband modem.

In a preferred embodiment of the present invention, the radio tuner is a satellite radio receiver. Satellite radio services provide an extensive number of channels, making navigation of the program guide difficult. Satellite radio provides specialized content, such as sports broadcasts, comedy channels, talk radio channels, and focused music channels. In an audio content environment, a program may be, for example, a sporting event, a particular disk jockey's program, a block of music, a comedy program, etc.

Preferred entertainment guide 204 receives audio from radio tuner 202 and presents the audio through speakers 208. The preferred entertainment guide may also present a program guide. The program guide may be presented on a display screen. The listener may select preferred programs from the program guide. These preferred programs may be placed in a priority order.

While the listener is listening to radio programs, the preferred entertainment guide searches the program listing for programs that match the priority listing. Matching programs are placed in a results list in priority order. If a program exists in the results list that has a higher priority than the program currently being played, then the preferred entertainment may alert the listener. At predetermined periods, such as every half hour or five minutes before each half hour, the preferred entertainment guide may generate a new results list. At this time, the listener may select a program from the results list.

The preferred entertainment guide may use tuning link 206 to change channels in the radio tuner. The tuning link may be, for example, an infrared communications link or a serial cable. When the listener selects a program from the results list, the preferred entertainment guide uses the tuning link to change channels.

The preferred entertainment guide may be a separate device that works in combination with the radio tuner. The preferred entertainment guide and radio tuner may also be integrated within a stereo system.

Turning now to FIG. 2B, the radio system includes radio tuner 212 and speakers 218. In the example shown in FIG. 2B, preferred entertainment guide 214 is integrated within radio tuner 212. The radio tuner may receive a program guide from a telephone connection or network. Alternatively, the program guide may be received by other media, such as removable media, radio frequency communication, infrared communication, etc. For example, the program guide may be received or updated using a compact disk.

Preferred entertainment guide 214 may present a program guide on a display screen. The listener may select preferred programs from the program guide. These preferred programs may be placed in a priority order. While the listener is listening to radio programs, the preferred entertainment guide searches the program listing for programs that match the priority listing. Matching programs are placed in a results list in priority order. If a program exists in the results list that has a higher priority than the program currently being viewed, then the preferred entertainment may alert the listener. At predetermined periods, such as every half hour or five minutes before each half hour, the preferred entertainment guide may generate a new results list. At this time, the listener may select a program from the results list.

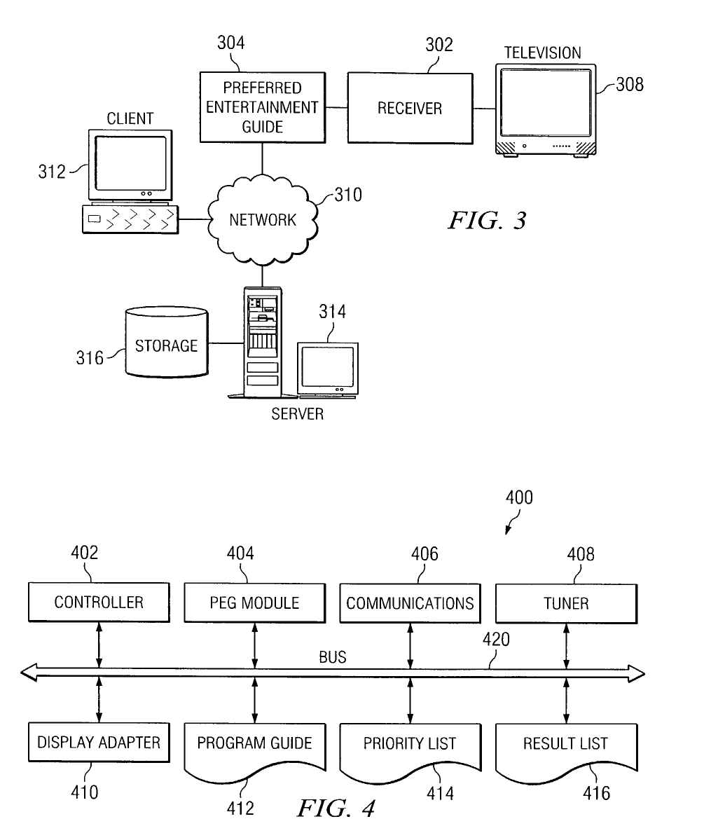

FIG. 3 depicts a pictorial representation of a network of data processing systems in which the present invention may be implemented. Network data processing system 300 is a network of computers in which the present invention may be implemented. Network data processing system 300 contains a network 310, which is the medium used to provide communications links between various devices and computers connected together within network data processing system 300. Network 310 may include connections, such as wire, wireless communication links, or fiber optic cables.

In the depicted example, server 314 is connected to network 310 and provides access to storage unit 316. In addition, client 312 is connected to network 310. Clients 312 may be, for example, a personal computer or network computer. In the depicted example, server 310 provides data, such as programming guides and prioritized program lists to client 312. Clients 312 is a client to server 314. Network data processing system 300 may include additional servers, clients, and other devices not shown.

Preferred entertainment guide 304 is connected to network 310. Media receiver 302 receives a signal from a satellite dish, cable connection, or antenna. The media receiver may provide content, such as analog or digital television, analog or satellite radio, streaming audio or video, or other media that may be programmed. Preferred entertainment guide 304 is connected between media receiver 302 and a media output device, such as television 308.

The preferred entertainment guide may receive a program guide from a telephone connection or network. In a preferred embodiment of the present invention, the program guide is received from storage unit 316 via server 314. The preferred entertainment guide may also present the program guide on the media output device. The program guide may be presented on a portion of a screen or superimposed over video content. The viewer may select preferred programs from the program guide. These preferred programs may be placed in a priority order.

While the viewer is viewing television programs, the preferred entertainment guide searches the program listing for programs that match the priority listing. Matching programs are placed in a results list in priority order. If a program exists in the results list that has a higher priority than the program currently being viewed, then the preferred entertainment may alert the viewer. At predetermined periods, such as every half hour or five minutes before each half hour, the preferred entertainment guide may generate a new results list. At this time, the viewer may select a program from the results list.

The priority listing itself may be generated outside preferred entertainment guide 304. For example, a user may view a program guide using client 312. The program guide may be retrieved from storage 316 via server 314 and presented on a display. The user of client 312 may then select preferred programs from the program guide for inclusion in a priority listing. The user may also change the order of the priority listing using client 312. Presentation and manipulation of the program guide and the priority listing may be accomplished, for example, using a graphical user interface, such as a Web browser. This may be especially useful for audio programming, such as satellite radio, because an audio system may not have a display screen or user interface capable of manipulating a program guide or priority list.

Preferred entertainment guide 304 may be a separate device that works in combination with the media receiver. The preferred entertainment guide and media receiver may also be integrated within the media output device itself.

In the depicted example, network data processing system 300 is the Internet with network 310 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 3 is intended as an example, and not as an architectural limitation for the present invention.

FIG. 4 is an exemplary block diagram of a preferred entertainment guide device in accordance with a preferred embodiment of the present invention. Preferred entertainment guide 400 includes controller 402, preferred entertainment guide (PEG) module 404, communications adapter 406, tuner 408, and display adapter 410. The elements 402-410 may be implemented as hardware, software, or a combination of hardware and software. In a preferred embodiment, PEG module 404 is implemented as software instructions executed by one or more processors.

The elements 402-410 are coupled to one another via the control/data signal bus 420. Although a bus architecture is shown in FIG. 4, the present invention is not limited to such. Rather, any architecture that facilitates the communication of control/data signals between elements 402-410 may be used without departing from the spirit and scope of the present invention. The controller 402 controls the overall operation of the preferred entertainment guide and orchestrates the operation of the other elements 404-410.

With the operation of the present invention, PEG module 404 instructs controller 402 to retrieve, store, and display a program guide. When a program listing is retrieved using communications adapter 406, the program listing may be stored in program guide 412. PEG module 404 also instructs controller 402 to present an interface, via display adapter 410, for presenting program guide 412 and for generating, presenting, and manipulating priority list 414. The user may generate priority list 414 using an interface presented using display adapter 410. Alternatively, a priority list may be retrieved using communications adapter 406 and stored in priority list 414. Communications adapter 404, which may be, for example, a network adapter, a modem, a serial port, or the like.

While the viewer is viewing media programs, the PEG module searches program guide 412 for programs that match priority list 414. Matching programs are placed in results list 416 in priority order. If a program exists in the results list that has a higher priority than the program currently being viewed, then the preferred entertainment guide may alert the viewer. At predetermined periods, such as for example every half hour, five or ten minutes before each half hour, or five or ten minutes before each hour, the PEG module may generate a new results list. At this time, the viewer may select a program from the results list.

Channels are changed by the preferred entertainment guide using tuner 408. In the case of an integrated PEG/media receiver device, tuner 408 may be an actual television or radio tuner. If preferred entertainment guide 400 is a separate device, tuner 408 may be a communications link to a media receiver, such as a serial port or infrared transmitter.

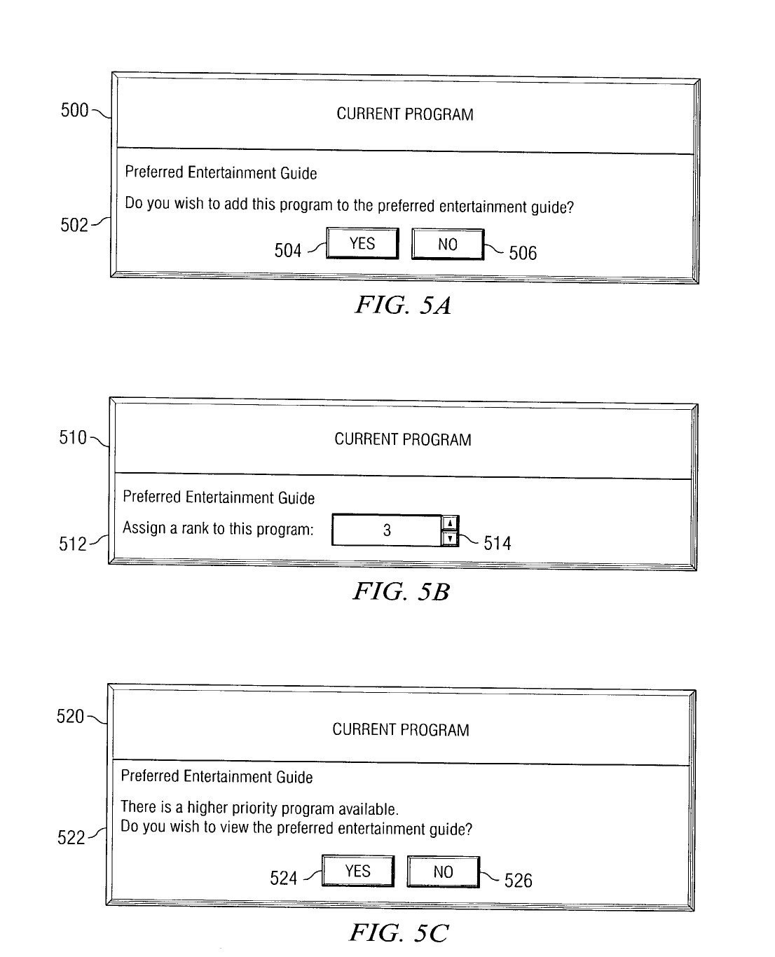

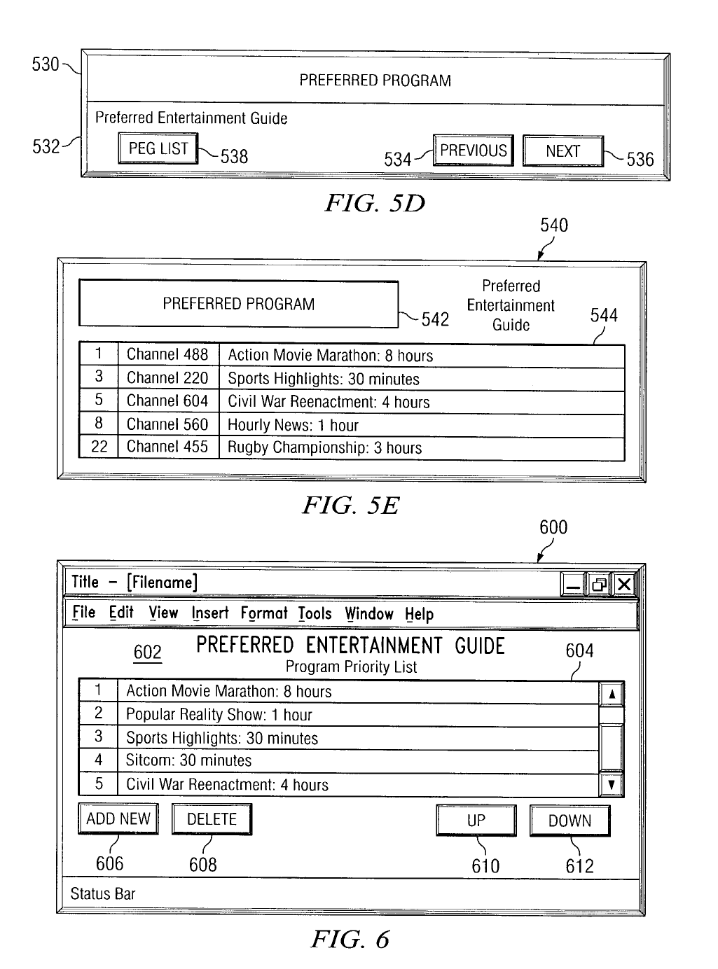

With reference to FIGS. 5A-5E, example television screens of display with preferred entertainment guide interfaces are shown in accordance with a preferred embodiment of the present invention. More particularly, with reference to FIG. 5A, television screen 500 includes preferred entertainment guide interface 502. Using interface 502, a viewer is presented with the option of including a currently viewed program in a preferred entertainment listing or priority listing. The viewer may select “YES” button 504 to add the program to the listing or “NO” button 506 to decline adding the current program to the priority listing. “YES” button 504 may be highlighted by default.

Turning to FIG. 5B, television screen 510 includes preferred entertainment guide interface 512. Using interface 512, a viewer may assign a rank value to the program. Interface 512 includes rank value field 514. The viewer may enter a rank value using a remote control, keyboard, or the like. Alternatively, the viewer may increase or decrease the value in the field by selecting up and down buttons within the interface or using up and down buttons on a remote control or other input device.

The priority listing may be ordered based upon the rank value of each program in the listing. For example, a program with a value of one may be the highest priority program. Programs within the priority listing may be allowed to have the same rank value. Programs with the same value may be ordered alphabetically, by the order of time of addition to the list, or by some other convention. Alternatively, two or more programs may not be allowed to have the same rank value. Thus, when a program is assigned a rank value of three, the program that previously had the value of three may be incremented to four and the program with a value of four may be incremented to five and so on. Other rank value conventions may also be used within the scope of the present invention. For example, a user may assign a program a number of stars or give a program a score on a scale of one to ten. In this example, the higher the value, the more preferred the program is.

With reference now to FIG. 5C, television screen 520 includes preferred entertainment guide interface 522. While the viewer is viewing television programs, the preferred entertainment guide searches a program guide for programs that match the priority list. Matching programs are placed in a results list in priority order. If a program exists in the results list that has a higher priority than the program currently being viewed, then the preferred entertainment guide may alert the viewer by presenting interface 522. At predetermined periods, such as every half hour, the preferred entertainment guide may generate a new results list. At this time, the viewer may be prompted to decide whether to select a program from the results list. The viewer may then select “YES” button 524 to view the preferred entertainment guide. The viewer may select “NO” button 526 to return to the program being currently viewed. “YES” button 524 may be highlighted by default.

Turning now to FIG. 5D, television screen 530 includes preferred entertainment guide interface 532, which may be presented in response to the viewer selecting “YES” button 524 in FIG. 5C. Preferred entertainment guide interface 532 includes “PREVIOUS” button 534, “NEXT” button 536, and “PEG LIST” button 538. Television display 530 may automatically switch to the first program in the results list, upon presentation of the preferred entertainment guide. The viewer may traverse the results list of preferred programs using “NEXT” button 536 and “PREVIOUS” button 534. “NEXT” button 536 may be highlighted by default. Alternatively, the viewer may select “PEG LIST” button 538 to view the entire results list.

With reference to FIG. 5E, television screen 540 includes preferred entertainment guide interface 542, which may be presented in response to the viewer selecting “PEG LIST” button 538 in FIG. 5D. Preferred entertainment guide interface 542 includes results list 544. Television display 540 may automatically switch to the appropriate channel as the viewer selects programs in results list 544.

With reference to FIG. 6, a screen of display for a remote preferred entertainment guide interface is shown in accordance with a preferred embodiment of the present invention. Preferred entertainment guide interface window 600 includes display area 602. Interface window 600 may be presented, for example, in a Web browser client application. This interface may be used to select and manage preferred programs for generating in a priority listing. The priority listing may be stored locally or on a network. In a preferred embodiment of the present invention, the resulting priority listing is stored on a server, such as a Web server.

Display area 602 includes priority list 604. Selected preferred programs are presented in priority order in list 604. A user may add a new program by selecting “ADD NEW” button 606. The user may then be presented with a program guide (not shown) for selection of preferred programs to add to the priority listing. The user may also remove programs from the priority listing by selecting “DELETE” button 608.

Furthermore, the user may modify the order of the programs in priority listing 604 by selecting a program in the list and selecting “UP” button 610 to move the program up in the list or “DOWN” button 612 to move the program down the list. Thus, using the interface in preferred entertainment guide interface window 600, the user may generate, modify, and store a priority listing for use with a preferred entertainment guide device. The preferred entertainment guide device may then retrieve the priority listing for use in generating a preferred entertainment guide interface on a media display.

A program may be added to the preferred program listing by title or by other criteria. For example, a program may be added to the preferred entertainment listing by title and episode. A user may also add a program by subject matter, such as professional football or science fiction movie. Alternatively, a priority may be assigned to all programs by a particular director or including a specific actor, athlete, or sports team.

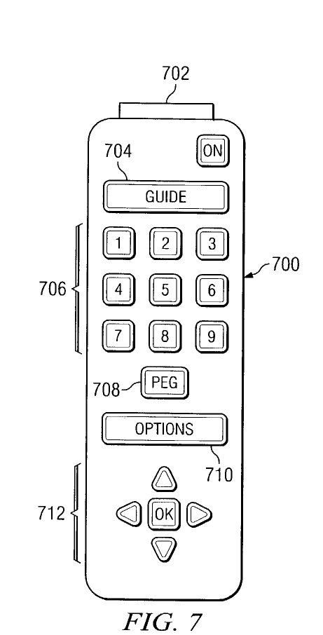

FIG. 7 illustrates a remote control device for use with a preferred entertainment guide device in accordance with a preferred embodiment of the present invention. Remote control 700 includes a plurality of buttons for operating a preferred entertainment guide device. Commands are sent from remote control 700 to the preferred entertainment guide using transmitter 702. The transmitter may be, for example, an infrared or radio frequency transmitter, as known in the art.

“GUIDE” button 704 allows the viewer to invoke a program guide interface. Using the program guide interface, the user may view all of the channels and programs available. Number buttons 706 may be used to enter rank values or channel numbers. “PEG” button 708 may be used to invoke a preferred entertainment guide interface.

“OPTIONS” button 710 may be used to invoke an options interface, which may allow a user to set options for the preferred entertainment guide. For example, a user may set the results list generation period. After each passing of the results list generation period, preferred entertainment guide generates a results list. A user may also set the amount of time before each results list generation period the preferred entertainment guide generates a results list.

Directional buttons 712 may be used to navigate the various preferred entertainment guide interfaces. The user may move a cursor up, down, left, and right using these buttons. The “OK” button may be depressed to select a highlighted graphical element in one of the preferred entertainment guide interfaces.

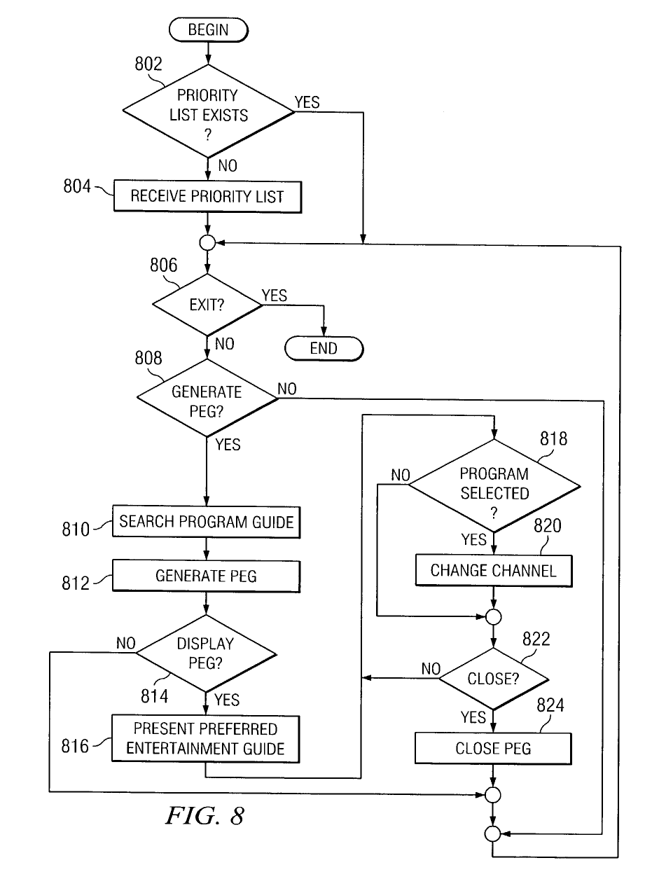

With reference now to FIG. 8, a flowchart illustrating the operation of a preferred entertainment guide is shown in accordance with a preferred embodiment of the present invention. The process begins and a determination is made as to whether a priority list exists in the preferred entertainment guide device (step 802). If a priority list does not exist, the process receives a priority list (step 804) and a determination is made as to whether an exit condition exists (step 806).

If a priority list does exist in step 802, the process proceeds directly to step 806 to determine whether an exit condition exists. An exit condition may exist, for example, if the user turns off the preferred entertainment guide device. If an exit condition exists, the process ends. If an exit condition does not exist in step 806, a determination is made as to whether a preferred entertainment guide interface should be created (step 808). A preferred entertainment guide interface may be generated, for example, every half hour or every hour. Step 808 may determine whether the current time matches the criteria for generating a preferred entertainment guide interface.

If a preferred entertainment guide interface is to be created in step 808, the process searches the program guide (step 810) for programs that match the priority list. Matching programs are placed in a results list in priority order. The process then generates a preferred entertainment guide interface (step 812) and a determination is made as to whether the preferred entertainment guide interface is to be displayed (step 814). If a preferred entertainment guide interface is not to be generated in step 808, the process returns to step 806 to determine whether an exit condition exists.

If the preferred entertainment guide interface is to be displayed in step 814, the process presents the preferred entertainment guide (step 816) and a determination is made as to whether a program is selected from the preferred entertainment guide (step 818). If the preferred entertainment guide interface is not to be displayed in step 814, the process returns to step 806 to determine whether an exit condition exists.

If a program is selected in step 818, the process changes the channel to the selected program (step 820) and a determination is made as to whether to close the preferred entertainment guide (step 822). The preferred entertainment guide may be closed in response to receiving a specific command from the viewer, such as by remote control. Alternatively, the preferred entertainment guide may be closed if a predetermined amount of time passes without activity from the user.

If a program is not selected in step 818, the process proceeds directly to step 822 to determine whether to close the preferred entertainment guide. If the preferred entertainment guide is not to be closed, the process returns to step 818 to determine whether a program is selected. If the preferred entertainment guide is to be closed in step 818, the process closes the preferred entertainment guide (step 824) and returns to step 806 to determine whether an exit condition exists.

Thus, the present invention solves the disadvantages of the prior art by allowing a listener or viewer to generate a prioritized list of media programs. The preferred entertainment guide searches the program listing for programs that match the priority listing. Matching programs are placed in a results list in priority order. If a program exists in the results list that has a higher priority than the program currently being viewed, then the preferred entertainment may alert the viewer. At predetermined periods, such as every half hour, the preferred entertainment guide will generate a new results list. At this time, the viewer may select a program of channel from the results list. The viewer may simply turn on a television or radio without having to search extensive program listings for a program of interest.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for controlling media selection, the method comprising:
receiving a priority list, wherein the priority list associates priority values with a plurality of priority programs;
receiving a program guide, wherein the program guide includes a plurality of scheduled programs;
comparing the program guide with the priority list to form a results list including at least one currently scheduled program in the program guide that matches a priority program in the plurality list; and
generating a preferred entertainment guide interface if a program in the results list has a higher priority than a program currently being presented.

2. The method of claim 1, wherein the preferred entertainment guide interface allows a user to cycle through only programs in the results list.

3. The method of claim 1, wherein the step of receiving a priority list includes:
generating a priority interface including a priority field for a given program;
receiving a priority value that is entered in the priority field; and
assigning the priority value to the given program.

4. The method of claim 1, wherein the step of receiving a priority list includes:
generating a priority interface, wherein the priority interface presents the plurality of priority programs and includes controls for changing the order of the plurality of priority programs in the priority interface to form a changed order of priority; and
in response to interaction with the priority interface, changing priority values of the plurality of priority programs to correspond to the changed order of priority.

5. The method of claim 1, wherein the step of receiving a priority list includes receiving the priority list from a database.

6. The method of claim 1, wherein the comparing step is performed responsive to a given event.

7. The method of claim 6, wherein the method is performed by a preferred entertainment guide device and wherein the given event is the preferred entertainment guide device being turned on.

8. The method of claim 6, wherein the given event is a current time reaching a predetermined time.

9. The method of claim 8, wherein the predetermined time is one of each half hour and five minutes before each half hour.

10. The method of claim 1, wherein programs in the program guide include one of television programs and radio programs.

11. The method of claim 1, wherein the preferred entertainment guide interface includes a control for presenting the results list.

12. A system for controlling media selection, the apparatus comprising:
a media receiver;
a media presentation device; and
a preferred entertainment guide device coupled to the media receiver and the media presentation device,
wherein the preferred entertainment guide device receives a current media program from the media receiver, provides the current media program to the media presentation device, receives a priority list for a plurality of priority programs, receives a program guide for scheduled programs, compares the program guide with the priority list to form a results list including at least one scheduled program currently being broadcast that matches a priority program in priority list, and generates a preferred entertainment guide interface if a program in the results list has a higher priority than the media program currently being presented.

13. The system of claim 12, wherein the preferred entertainment guide interface allows a user to cycle through only programs in the results list.

14. The system of claim 12, wherein the media receiver is one of a television tuner, a cable television receiver, a satellite receiver, a frequency modulated radio receiver, and a satellite radio receiver.

15. The system of claim 12, further comprising a communications interface.

16. The system of claim 15, wherein the preferred entertainment guide device receives the priority list via the communications interface.

17. The system of claim 15, wherein the preferred entertainment guide device receives the program guide via the communications interface.

18. The system of claim 15, wherein the communications interface is one of a network interface and a modem.

19. The system of claim 12, wherein the preferred entertainment guide device sends a channel changing signal to the media receiver via a tuning link.

20. A computer program product, in a computer readable medium, for controlling media selection, the computer program product comprising:
instructions for receiving a priority list, wherein the priority list associates priority values with a plurality of priority programs;
instructions for receiving a program guide, wherein the program guide includes a plurality of scheduled programs;
instructions for comparing the program guide with the priority list to form a results list including at least one currently scheduled program in the program guide that matches a priority program in the plurality list; and
instructions for generating a preferred entertainment guide interface if a program in the results list has a higher priority than a program currently being presented.
